(19) United States
(12) Patent Application Publication
(10) Pub. No.: US 2018/0246354 A1
(43) Pub. Date: Aug. 30, 2018

(54) ELECTRICALLY FOCUS-TUNABLE LENS

(71) Applicant: DigiLens, Inc., SUNNYVALE, CA (US)

(72) Inventors: Milan Momcilo POPOVICH, LEICESTER (GB); Jonathan David WALDERN, LOS ALTOS HILLS, CA (US); Alastair John GRANT, SAN JOSE, CA (US)

(73) Assignee: DigiLens, Inc., SUNNYVALE, CA (US)

(21) Appl. No.: 15/553,120

(22) PCT Filed: Feb. 22, 2016
(86) PCT No.: PCT/GB2016/000036

§ 371 Date: Aug. 23, 2017

Related U.S. Application Data
(60) Provisional application No. 62/176,572, filed on Feb. 23, 2015.

(51) Int. Cl. G02F 1/1334; G02F 1/1335

(52) U.S. Cl. CPC G02F 1/1334; G02F 1/133504; G02F 1/133526

(57) ABSTRACT

An electrically focus-tunable lens having a passive lens and a liquid crystal diffractive lens both sandwiched between a first transparent substrate with a first electrode applied to one surface and a second transparent substrate with a second electrode applied to one surface. The electrodes are operative to apply at least one voltage across the liquid crystal diffractive lens

### PRIORITY CLAIMS

This application claims priority from U.S. Provisional Application Ser. No. 62/176,572 entitled ELECTRICALLY FOCUS-TUNABLE LENS filed on 23 Feb. 2015, which is hereby incorporated by reference in its entirety.

### CROSS REFERENCE TO RELATED APPLICATIONS

The following patent applications are incorporated by reference herein in their entireties: U.S. patent application Ser. No. 13/506,389 entitled COMPACT EDGE ILLUMINATED DIFFRACTIVE DISPLAY, U.S. Pat. No. 8,233,204 entitled OPTICAL DISPLAYS, PCT Application No.: US2006/043938, entitled METHOD AND APPARATUS FOR PROVIDING A TRANSPARENT DISPLAY, PCT Application No.: GB2012/000677 entitled WEARABLE DATA DISPLAY, U.S. patent application Ser. No. 13/317,468 entitled COMPACT EDGE ILLUMINATED EYEGLASS DISPLAY, U.S. patent application Ser. No. 13/869,866 entitled HOLOGRAPHIC WIDE ANGLE DISPLAY, and U.S. patent application Ser. No. 13/844,456 entitled TRANSPARENT WAVEGUIDE DISPLAY, U.S. Pat. No. 8,224,133 entitled LASER ILLUMINATION DEVICE, U.S. Pat. No. 8,565,560 entitled LASER ILLUMINATION DEVICE, U.S. Pat. No. 6,115,152 entitled HOLOGRAPHIC ILLUMINATION SYSTEM, PCT Application No.: PCT/GB2013/000005 entitled CONTACT IMAGE SENSOR USING SWITCHABLE BRAGG GRATINGS, PCT Application No.: PCT/GB2012/000680, entitled IMPROVEMENTS TO HOLOGRAPHIC POLYMER DISPERSED LIQUID CRYSTAL MATERIALS AND DEVICES.

### BACKGROUND OF THE INVENTION

This invention relates to an optical device, and more particularly to an electrically focus-tunable lens based on liquid crystal diffractive optical technology. The ability to fine-tune the focus of an optic is important in many applications. In near-eye technology there is a requirement to adjust the display focus to accommodate users' spectacle prescriptions. In some applications such as light field displays, which provide multiple focal planes to create a 3D experience, there is a need to vary the focal length in a more dynamic fashion as the eye focus moves from one plane to another. Ophthalmic optics presents a further opportunity for a focus-tunable lens. Here there is a need for improved contact lenses for the correction of presbyopia; the loss of visual accommodation with age. Currently, available multi-focal contact lenses achieve some degree of compensation by providing two or more distinct lens powers: in the case of a bifocal one power for distance vision and one for near. Other contact lenses provide a gradual change in lens power for a natural visual transition from distance to close-up. The goal of current research is a contact lens where focus is adjusted uniformly and dynamically over the entire clear aperture of the pupil, thus restoring prepresbyopic vision in a more natural manner. Other methods of making compact non-mechanical focus-tunable lenses are currently under investigation, including: non-diffractive liquid-crystal lenses, electro-wetting lenses, and membrane fluidic lenses. Non-diffractive liquid crystal lens use liquid crystal in a curved cavity formed by two curved substrates. The thick liquid crystal layer is typically as high as 50 microns leading to high switching voltages. Electro-wetting uses two immiscible liquids such as oil and water. When a voltage is applied across the liquids, the curvature of interface and hence the focal length is changed. However, the required voltages are in the order of several tens or even over a hundred volts making this approach unsuitable for contact lens application. Fluidic lenses normally employ a deformable membrane chamber. Pressure-controlled fluidic lenses use a syringe and a pump system to alter the volume of the fluid inside the chamber and hence vary the focal length. Alignment, evaporation, slow response time, and bulky peripherals are some of the current issues with fluidic lenses. Diffractive optical solutions offer the most promising route to a compact efficient focus-tunable contact lens. The most common approach uses two main components: a flat diffractive element, and a thin layer of liquid crystal sandwiched between two thin ITO glass substrates, one with the diffractive pattern and one with no pattern used as the electronic ground. The refractive index of the liquid crystal can be varied with the applied voltage and together with the diffractive pattern that defines the phase-wrap points, phase profiles corresponding to different focal lengths can be achieved. To date, diffractive LC solutions have suffered from low efficiency, colour dispersion and aberrations and high power consumption. There is a requirement for an optically efficient, low power, compact liquid crystal diffractive focus-tunable lens.

### SUMMARY OF THE INVENTION

It is a first object of the invention to provide an optically efficient, low power, compact liquid crystal diffractive focus-tunable lens.

The object of the invention is achieved in first embodiment of the invention in which an electrically focus-tunable lens comprises: a passive lens; a liquid crystal diffractive lens; a first transparent substrate with a first electrode applied to one surface; and a second transparent substrate with a second electrode applied to one surface. The electrodes apply at least one voltage across the LC diffractive lens layer.

In one embodiment the passive lens is a hologram of a multilevel diffractive structure.

In one embodiment the passive lens is a hologram of a refractive lens.

In one embodiment the passive lens is a substrate having a surface relief grating formed in one surface.

In one embodiment the passive lens is a refractive medium having at least one curved surface.

In one embodiment the liquid crystal diffractive lens is a liquid crystal layer.

In one embodiment the liquid crystal diffractive lens is a switchable hologram of one of a multilevel diffractive structure or a refractive lens. The switchable hologram provides at least two unique optical powers.

In one embodiment the liquid crystal diffractive lens comprises a substrate having a surface relief grating formed in one surface and a liquid crystal layer in contact with the surface relief grating.

In one embodiment the passive lens is a surface relief grating the liquid crystal diffractive lens is a liquid crystal layer, where the liquid crystal layer is in contact with the surface relief grating.

In one embodiment the apparatus further comprises an alignment layer.

In one embodiment the apparatus further comprises a layer containing liquid crystal or a reactive mesogen having a spatially-varying distribution of director orientations.

In one embodiment the apparatus further comprises at least one barrier layer.

In one embodiment at least one surface of at least one of the substrates has refractive or diffractive optical power.

In one embodiment the electrodes are applied to opposing surfaces of the first and second substrates.

In one embodiment the first electrode is patterned with a multiplicity of selectively addressable concentric rings. Each ring and the second electrode apply at least one voltage across a region of the liquid crystal diffractive lens overlaid by the ring.

In one embodiment the first electrode is patterned with a multiplicity of selectively addressable concentric rings. Each ring contains two or more selectively addressable concentric sub-rings. Each sub-ring and the second electrode apply at least one voltage across a region of the liquid crystal diffractive lens overlaid by the ring.

In one embodiment the first electrode is patterned with an array of selectively addressable pixels. Each pixel and the second electrode apply at least one voltage across a region of the liquid crystal diffractive lens overlaid by the pixel.

In one embodiment the apparatus is configured as a curved stack.

In one embodiment the passive lens contains a conductive additive.

In one embodiment the optical power of the liquid crystal diffractive lens with no voltage applied and the optical power of the passive lens and the substrates together provides a minimum predefined optical power. The optical power of the liquid crystal diffractive lens with voltage applied and the optical power of the passive lens and the substrates together provide a maximum predefined optical power.

In one embodiment the liquid crystal diffractive lens is fabricated in a material containing at least one bistable liquid crystal.

In one embodiment the liquid crystal diffractive lens is a Bragg grating or a Switchable Bragg Grating and is recorded in one of a HPDLC grating, uniform modulation grating or reverse mode HPDLC grating.

A more complete understanding of the invention can be obtained by considering the following detailed description in conjunction with the accompanying drawings, wherein like index numerals indicate like parts. For purposes of clarity, details relating to technical material that is known in the technical fields related to the invention have not been described in detail.

### BRIEF DESCRIPTION OF THE DRAWINGS

FIG. 1A is a schematic illustration of a focus-tunable lens in one embodiment.

FIG. 1B is a schematic illustration of a focus-tunable lens in one embodiment.

FIG. 1C is a schematic illustration of a focus-tunable lens in one embodiment.

FIG. 2 is a schematic illustration of a patterned electrode comprising concentric rings in one embodiment.

FIG. 3 is a schematic illustration of a patterned electrode comprising concentric rings in one embodiment.

FIG. 4 is a schematic illustration of a patterned electrode comprising concentric rings in one embodiment.

FIG. 5 is a schematic illustration of a patterned electrodes comprised a two dimensional array of electrode elements in one embodiment.

FIG. 6 is a schematic illustration of a focus-tunable lens in one embodiment.

FIG. 7 is a schematic illustration of a focus-tunable lens in one embodiment.

FIG. 8 is a schematic illustration of a focus-tunable lens in one embodiment.

FIG. 9 is a schematic illustration of a focus-tunable lens in one embodiment.

FIG. 10 is a schematic illustration of a focus-tunable lens in one embodiment.

FIG. 11 is a schematic illustration of a focus-tunable lens in one embodiment.

FIG. 12 is a schematic illustration of a focus-tunable lens in one embodiment.

FIG. 13 is a schematic illustration of a focus-tunable lens in one embodiment.

FIG. 14 is a schematic illustration of a focus-tunable lens in one embodiment.

FIG. 15 is a schematic illustration of a focus-tunable lens in one embodiment.

FIG. 16 is a schematic illustration of a focus-tunable lens in one embodiment.

FIG. 17 is a schematic illustration of a focus-tunable lens in one embodiment.

FIG. 18 is a schematic illustration of a focus-tunable lens in one embodiment.

FIG. 19 is a passive holographic lens used in one embedment.

FIG. 20 is an alignment layer in one embodiment.

FIG. 21 is a voltage distribution applied to the liquid crystal diffractive lens in one embodiment.

FIG. 22 is a schematic illustration of a focus-tunable lens in one embodiment.

FIG. 23 is a schematic illustration of a focus-tunable lens in one embodiment.

FIG. 24 is a schematic illustration of a focus-tunable lens in one embodiment.

FIG. 25 is a schematic illustration of a focus-tunable lens in one embodiment.

### DETAILED DESCRIPTION OF THE INVENTION

The invention will now be further described by way of example only with reference to the accompanying drawings. It will apparent to those skilled in the art that the present invention may be practiced with some or all of the present invention as disclosed in the following description. For the purposes of explaining the invention well-known features of optical technology known to those skilled in the art of optical design and visual displays have been omitted or simplified in order not to obscure the basic principles of the invention. Unless otherwise stated the term “on-axis” in relation to a ray or a beam direction refers to propagation parallel to an axis normal to the surfaces of the optical components described in relation to the invention. In the following description the terms light, ray, beam and direction may be used interchangeably and in association with each other to indicate the direction of propagation of light energy along rectilinear trajectories. Parts of the following description will be presented using terminology commonly employed by those skilled in the art of optical design. It should also be noted that in the following description of the invention repeated usage of the phrase “in one embodiment” does not necessarily refer to the same embodiment.

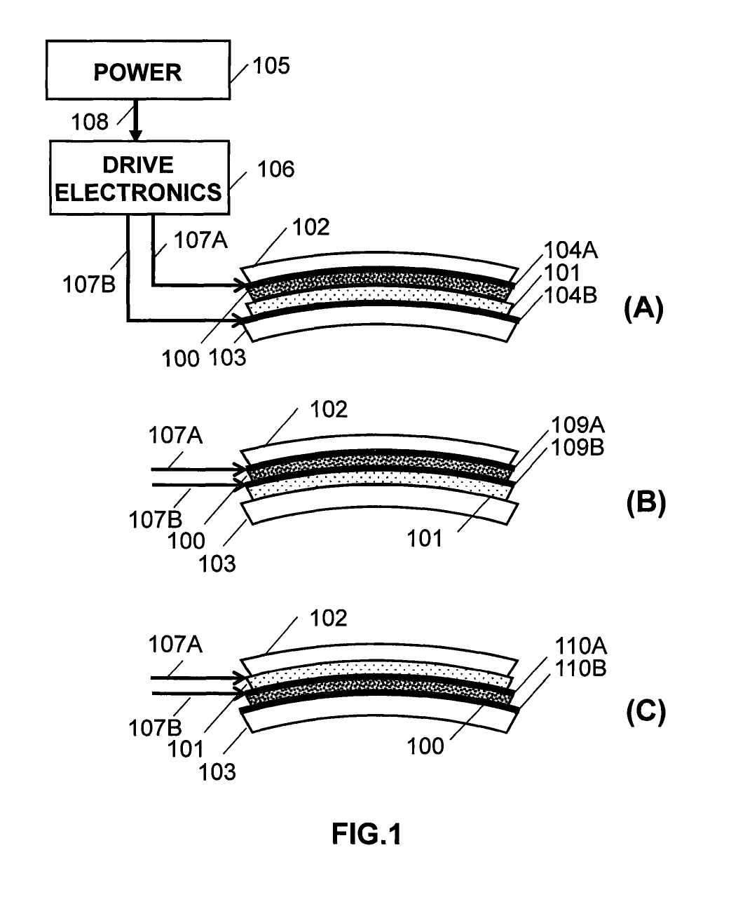

FIG. 1 illustrates the basic principles of a focus-tunable lens according to the principles of the invention. The embodiment of FIG. 1 A comprises a liquid crystal diffractive lens 100 and a passive lens 101, a first transparent substrate 102 with a first electrode 104A applied to one surface; and a second transparent substrate 103 with a second electrode 104B applied to one surface. Advantageously, the electrodes are applied to opposing substrate surfaces. The electrodes apply at least one voltage across the LC diffractive lens layer. As will be explained below the first electrode may be patterned with selectively addressable elements to provide a tunable diffractive structure for varying the focal length of the liquid crystal diffractive lens. As shown in FIG. 1A the apparatus further comprises a power supply 105 and drive electronics for applying voltages to the LC diffractive lens layer. The power lines 107A,107B connect the drive electronics to the focus-tunable lens electrodes. The power supply is connected to the drive electronics by the power line 108. In contact lens applications the power supply will, advantageously, be based rechargeable, thin film, solid-state battery technology for compatibility with the form factor of a contact lens. These batteries can provide a voltage of approximately 4 volts but with very limited capacity. Keeping the optical layers of the focus-tunable lens as thin as possible is a key factor in reducing power consumption. In one group of embodiments illustrated by FIG. 1B the voltage is applied across the liquid crystal diffractive lens only using the electrodes 109A,109B. The electrode 109B will normally be applied to a separate thin transparent substrate disposed between the passive lens and LC diffractive lens layers. This is a more efficient arrangement in terms of power consumption. The invention allows the order of the passive lens and LC diffractive lens to be interchanged, as shown in FIG. 1C, where the electrode 110B is applied to the substrate 103 and the electrode 110A will typically be applied to an additional thin transparent substrate, which is not illustrated, disposed between the passive lens and LC diffractive lens. In ophthalmic applications the optical component layers will all be laminated into a curved stack as shown in FIG. 1. The invention may also be used to provide planar stacks.

The invention will now be discussed in more details with reference to a series of exemplary embodiment. It will quickly become apparent from consideration of the drawings and description that the invention allows for many different implementations of a focus-tunable lens based on combining a passive lens with a LC diffractive lens. It is to be understood that the invention is not limited to the disclosed exemplary embodiments. Various modifications, combinations, sub-combinations and alterations may occur depending on design requirements and other factors insofar as they are within the scope of the appended claims or the equivalents thereof. For the sake of simplicity, the illustrations of the following embodiments will be limited to planar stacks.

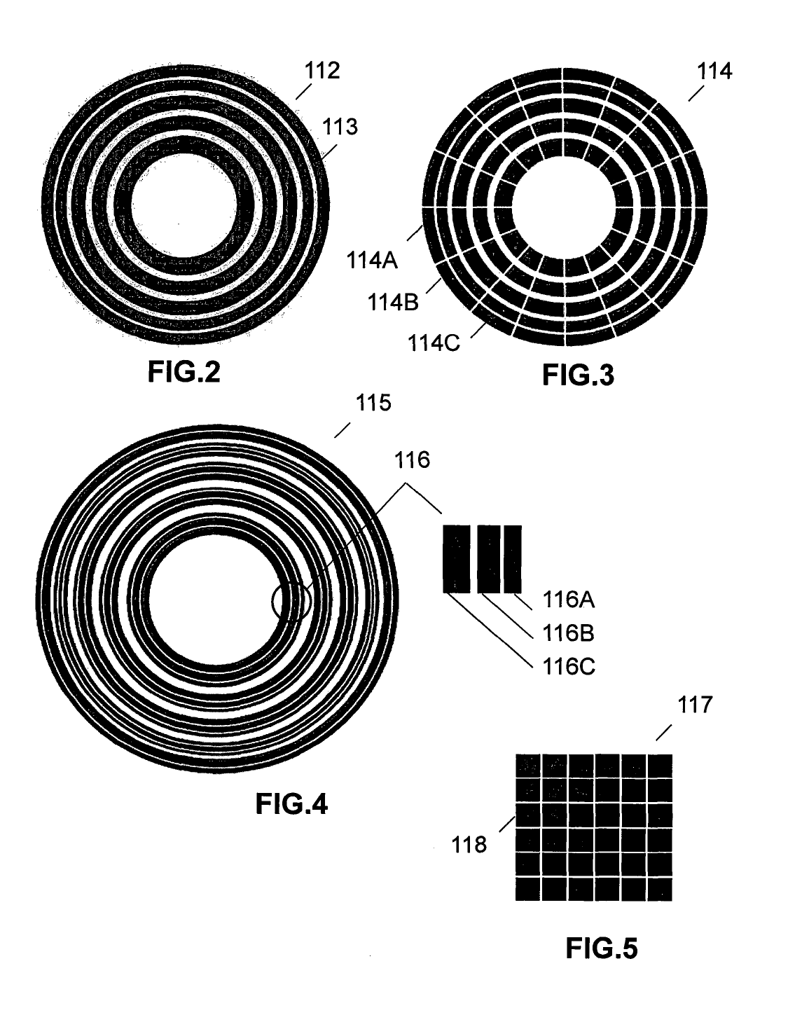

We first consider embodiments in which the LC diffractive lens uses at least one patterned electrode. In one embodiment illustrated in FIG. 2 the first electrode 112 is patterned with a multiplicity of selectively addressable concentric rings such as 113. Essentially, the electrodes define a diffracting structure. Each ring and the second electrode apply at least one voltage across a region of the liquid crystal diffractive lens overlaid by the ring. Typically, the voltage is applied in discrete steps. Typically, around 8-12 voltage levels may be applied in each region. By such means it is possible to provide a multilevel refractive indicate profile within a LC layer approximating to that of commonly used lens forms including spherical and Fresnel. In one embodiment illustrated in FIG. 3 the first electrode 114 is patterned such that each ring of the embodiment of FIG. 2 is divided into selectively addressable regions such 114A-114C. In one embodiment illustrated in FIG. 4 the first electrode 115 is patterned with a multiplicity of selectively addressable concentric rings such as 116. Each ring contains two or more selectively addressable concentric sub-rings. For example, the ring 116 may contain sub rings 116A-116C. In the above electrode embodiments groups of electrodes are shunted and switched simultaneously to provide dynamically varying focal lengths. The lens focal length is given by rₙ²/(2 n λ) where rₙ is the radius of the nth ring. In one embodiment illustrated in FIG. 5 the first electrode 117 comprises a two dimensional array of selectively addressable pixels such as 118. An important advantage of the embodiments of FIG. 3 and FIG. 4 is that they are not limited to axisymmetric lens profiles and could be used to correct conditions such as astigmatism. It should be apparent from consideration of FIGS. 2-5 that many other electrodes architectures are possible. For example, one possible scheme would combine the features of the embodiments of FIG. 3 and FIG. 4.

The material conventionally used for transparent electrodes Indium Tin Oxide (ITO) suffers from reflectance, haze, brittleness and metal fatigue. ITO contains the toxic and increasingly scarce rare metal, indium. All of these are concerns in a contact lens. New transparent materials based on carbon nano-materials can overcome these problems. An exemplary one is the CNB™ developed by Canatu Inc. (www.canatu.com). Such materials are not limited by the brittleness or metal fatigue associated with ITO. They are thermo-formable maintaining conductivity even after 100% stretching and bending to less than 2 mm radius. Ambient reflections are much lower owing to the very small (close to zero) reflections resulting from the index being the same as OCA and PET substrates (with refractive index around 1.55); ITO has index 2.2. This results in higher contrast and the good optical matching of the CNB™ materials to the PET results in almost no haze. CNB™ has 96% transmission at 150 ohms/square sheet resistivity and almost perfect color neutrality. This gives vivid colors, and virtually invisible electrodes. The higher grating contrast results in lower power consumption and extended battery liver. The CNB™ material is manufactured using by a roll-roll process under atmospheric pressure that does not require toxic or caustic chemicals. The process is competitive with the existing and emerging transparent conductors. As a single-wall carbon nano-material it does not pose any health hazards.

The substrates used in the invention may be fabricated using cyclic olefin copolymers (COCs) such as the ones manufactured by TOPAS Inc. or cyclic olefin polymers (COPs) such as the ones manufactured by ZEON Corporation and sold under the trade names ZEONEX and ZEONOR. Both materials have excellent optical properties (including high transmission and low birefringence) and excellent physical properties (including low specific gravity, low moisture absorption, and relatively high glass transition temperature). Standard vacuum chamber processes for applying ITO coatings to substrates typically require high temperatures (˜300° C.); whereas the glass transition temperature of COCs and COPs are in the range of 130-160° C. However, the inventors are aware of low-temperature ITO coating processes specially developed for optical-quality polymers, such as TOPAS and ZEONEX. The inventors have found that electrodes fabricated from carbon nanotubes (CNTs), if deposited properly, are both robust and flexible. Plus, they can be applied much faster than ITO coatings, are easier to ablate without damaging the underlying plastic, and exhibit excellent adhesion. It is believed that existing CNT coating plant can be extended to COPs and COCs, especially since the latter have a number of innate advantages (such as high glass transition temperature and low moisture retention) over proven plastics, like PET and PEN. The inventors have found that COC substrates coated with CNT (resistivity of 230 Ω/sq) exhibit more than 85% transmission compared with 90% transmission obtained with ITO on the same substrate.

In one embodiment an adhesion layer is used to support the transparent conductive coating. Both TOPAS and ZEONEX have extraordinary optical and mechanical properties, ones which in many regards approach those of glass. Of particular interest beyond their optical properties are the facts that they are mechanically stable, have high surface smoothness, and are less hygroscopic than most plastics. However, attempting to apply transparent conductive coatings directly to the plastics has been found to result in poor to marginal adhesion. It is therefore desirable to use an adhesion layer.

In one group of embodiments the passive lens is a hologram of a multilevel diffractive structure and the LC diffractive lens is provided by a LC layer and electrodes of the type discussed above. The hologram may a Bragg grating or a Switchable Bragg Grating recorded in one of a HPDLC grating, uniform modulation grating or reverse mode HPDLC grating.

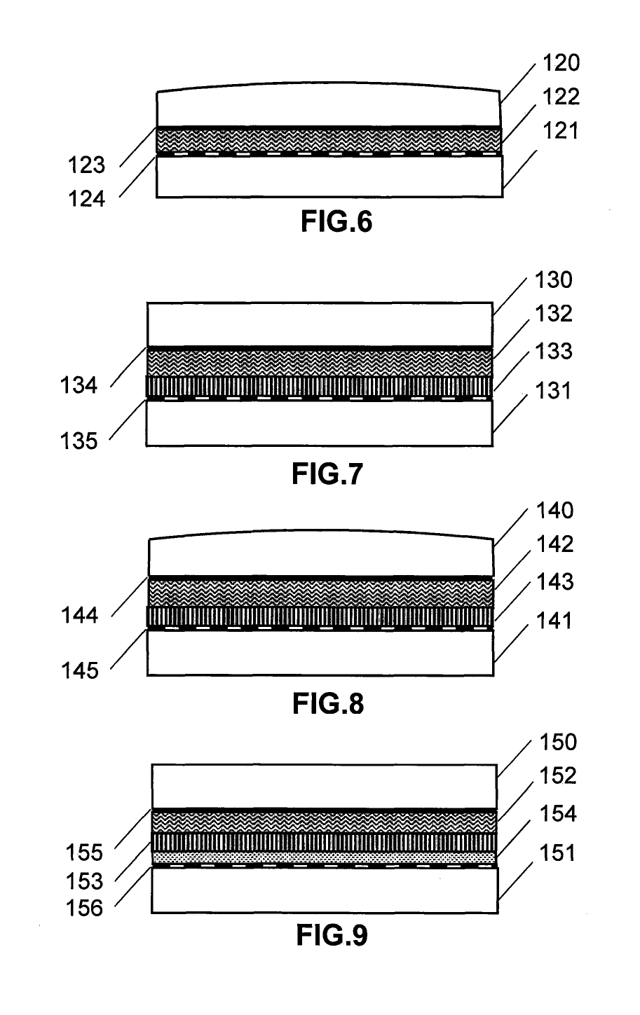

In one embodiment shown in FIG. 6 a focus-tunable lens comprises substrates 120,121 sandwiching a LC layer 122. A continuous electrode 123 and a patterned electrode 124 are applied to the opposing surfaces of the substrates 120,121. The liquid crystal layer provides the LC diffractive lens. The passive lens component in this embodiment is provided by applying a curvature to one or both of the substrates (substrate 120, in this case). Alternatively, optical power may be obtained by etching a diffractive structure onto or more of substrate surfaces. Normally external surfaces would be used for this propose owing to the difficulty of applying electrode coatings to a surface relief structure. Typically, the LC layer is from 1.5 to 3 micron in thickness.

In one embodiment shown in FIG. 7 a focus-tunable lens comprises the substrates 130,131 sandwiching the LC layer 132 and a passive holographic lens layer 133. A continuous electrode 134 and a patterned electrode 135 are applied to the opposing surfaces of the substrates 130,131.

In one embodiment shown in FIG. 8 a focus-tunable lens comprises the substrates 140,141 sandwiching the LC layer 142 and a passive holographic lens layer 143. A continuous electrode 144 and a patterned electrode 145 are applied to the opposing surfaces of the substrates 140,141. This embodiment is similar to the embodiment of FIG. 7 except in that one of the substrates (140) has a curved external surface.

In one embodiment shown FIG. 9 a focus-tunable lens comprises substrates 150,151 sandwiching the LC layer 152 and a passive holographic lens layer 153 and a barrier film 154 disposed between the substrate 151 and the passive holographic lens. Additional barrier films may be applied for the purposes of isolating layers of the focus-tunable lens from the environment and to prevent the release of toxic materials used in the layers into the eye. A continuous electrode 155 and a patterned electrode 155 are applied to the opposing surfaces of the substrates 150,151. Ideally a barrier film for use in the invention should have high transparency, low scatter, low birefringence, thermal and chemical stability coupled with a mechanically bendable form-factor. Cross-linked organic substrates such as polyimide (PI) or oxides (TEOS/TEOT) may provide effective barrier films. A range of polymeric barrier film materials is available from Merck and Nissan Chemicals. The inventors propose to fabricate the various lens layers on plasma cleaned surfaces. This will provide additional barrier/activation for active surfaces. In addition, Cyclic Olefinic Co-polymers (COCs) are known to have low water adsorption and very good barrier properties.

In one group of embodiments a surface relief grating is used as part of the LC diffractive lens or is used to provide a passive lens.

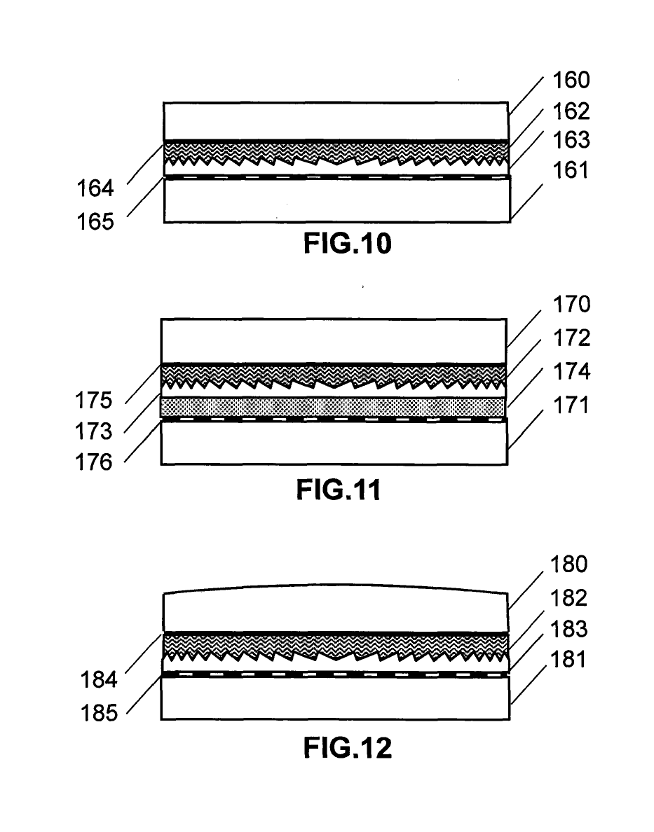

In one embodiment shown in FIG. 10 a focus-tunable lens comprises substrates 160,161 sandwiching the LC layer 162 (which provides the LC diffractive lens) and a surface relief grating 163 (which provides the passive lens). A continuous electrode 164 and a patterned electrode 165 are applied to the opposing surfaces of the substrates 160,161.

In one embodiment shown FIG. 11 a focus-tunable lens comprises substrates 170,171 sandwiching the LC layer 172, which provide the LC diffractive lens and a surface relief grating 173 which provides the passive lens. A barrier film 174 is disposed between the substrate 171 and the passive holographic lens. Additional barrier films may be applied for the purposes of isolating layers of the focus-tunable lens from the environment and to prevent the release of toxic materials used in the layers into the eye. A continuous electrode 175 and a patterned electrode 176 are applied to the opposing surfaces of the substrates 170,171.

In one embodiment shown in FIG. 12 a focus-tunable lens identical to the one of FIG. 10 is provided. The apparatus comprises substrates 180,181 sandwiching the LC layer 182, which provide the LC diffractive lens and the surface relief grating 183 which provides the passive lens. A continuous electrode 184 and a patterned electrode 185 are applied to the opposing surfaces of the substrates 180,181. This embodiment differs from the one of FIG. 10 in that the substrate 180 has a curved external surface.

In one group of embodiments the apparatus further comprises an alignment layer. In one embodiment the alignment layer uses reactive monomer materials for 3D bulk alignment of LC directors. The alignment in a reactive monomer material is produced by control of the UV exposure beam orientation during fabrication of the layer. The alignment layer may be used as a means of correcting polarization artefacts introduced by the grating layers. This may be done by compensating for the birefringence of the liquid crystal layer. The alignment layer may also be used to fine-tune the overall optical power of the apparatus.

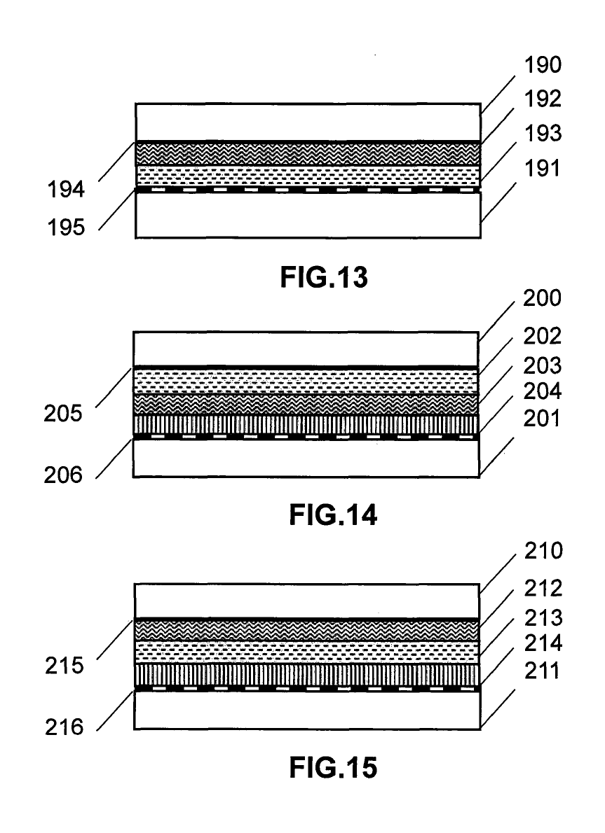

In one embodiment shown in FIG. 13 a focus-tunable lens comprises substrates 190,191 sandwiching the LC layer 192 and an alignment layer 193. A continuous electrode 194 and a patterned electrode 195 are applied to the opposing surfaces of the substrates 190,191.

In one embodiment shown in FIG. 14 a focus-tunable lens comprises substrates 200,201 a focus-tunable lens comprises substrates 210,211 sandwiching the LC layer 202, a passive holographic lens layer 204 and an alignment layer 203. A continuous electrode 205 and a patterned electrode 206 are applied to the opposing surfaces of the substrates 200,201.

In one embodiment shown in FIG. 15 a focus-tunable lens comprises substrates 210,211 sandwiching the LC layer 212, a passive holographic lens layer 214 and an alignment layer 213. A continuous electrode 215 and a patterned electrode 216 are applied to the opposing surfaces of the substrates 210,211. Note that this embodiment is similar to the one of FIG. 14 except that the orders of the LC layer and the alignment layer are interchanged. In any of the embodiments disclosed the invention allows for the insertion of an alignment layer at any level within the optical stack.

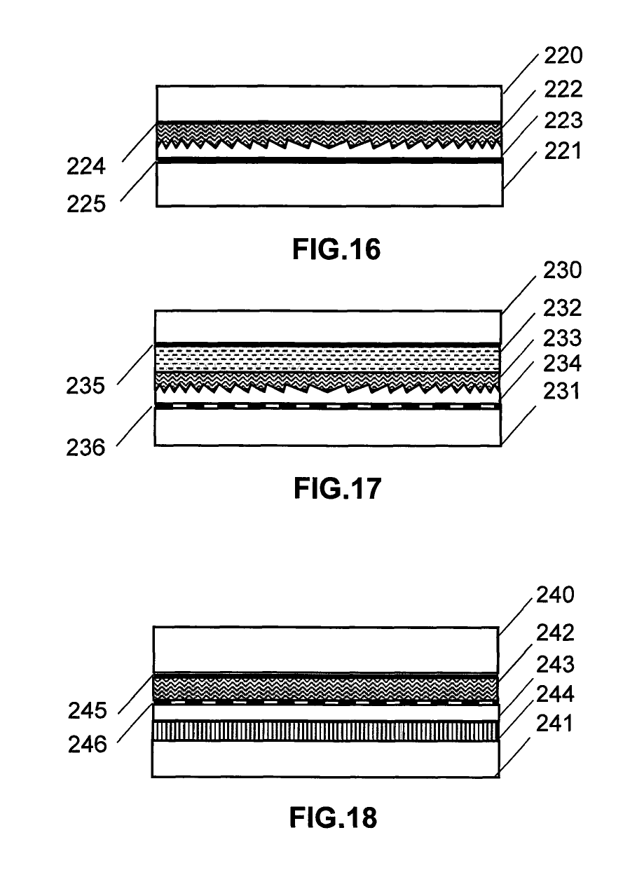

In certain embodiment a focus-tunable lens may be provided without the need for patterned electrodes. For example, in one embodiment shown in FIG. 16 a focus-tunable lens comprises substrates 220,221 sandwiching the LC layer 222, which provide the LC diffractive lens and the surface relief grating 223 which provides the passive lens. The continuous electrode 224, 225 are applied to the opposing surfaces of the substrates 220,221. Such embodiments may have limited focusing dynamic range and may be better suited to providing a bifocal or trifocal implementation of the invention.

In certain embodiments a focus-tunable lens may use a surface relief grating, liquid crystal layer and an alignment layer together with a patterned electrode. For example, in one embodiment shown in FIG. 17 a focus-tunable lens comprises substrates 230,231 sandwicihng the alignment layer 232, LC layer 234 which forms the LC diffractive lens, and the surface relief grating 234 which provides the passive lens. A continuous electrode 235 and a patterned electrode 236 are applied to the opposing surfaces of the substrates 230,231.

It is desirable that the material layer(s) thickness between the electrodes is as thin as possible to minimize power consumption. This is particular important in contact lens applications of the invention. To this end some embodiments of the invention are design to limit the layers sandwiched by the electrodes to the LC layer only. For example, in one embodiment shown in FIG. 18 a focus-tunable lens comprises substrates 240,241 sandwiching the LC layer 242, a further transparent substrate 243 and a passive holographic lens 244. A continuous electrode 245 and a patterned electrode 246 are applied to the opposing surfaces of the substrates 240,244. In embodiments where the voltage must be applied through several optical layers, the passive lens material (typically an optical polymer) may contain a conductive additive such as an electrically conductive ink. The conductive additive may be one of the materials fabricated by Asbury Graphite Mills Inc. (New Jersey).

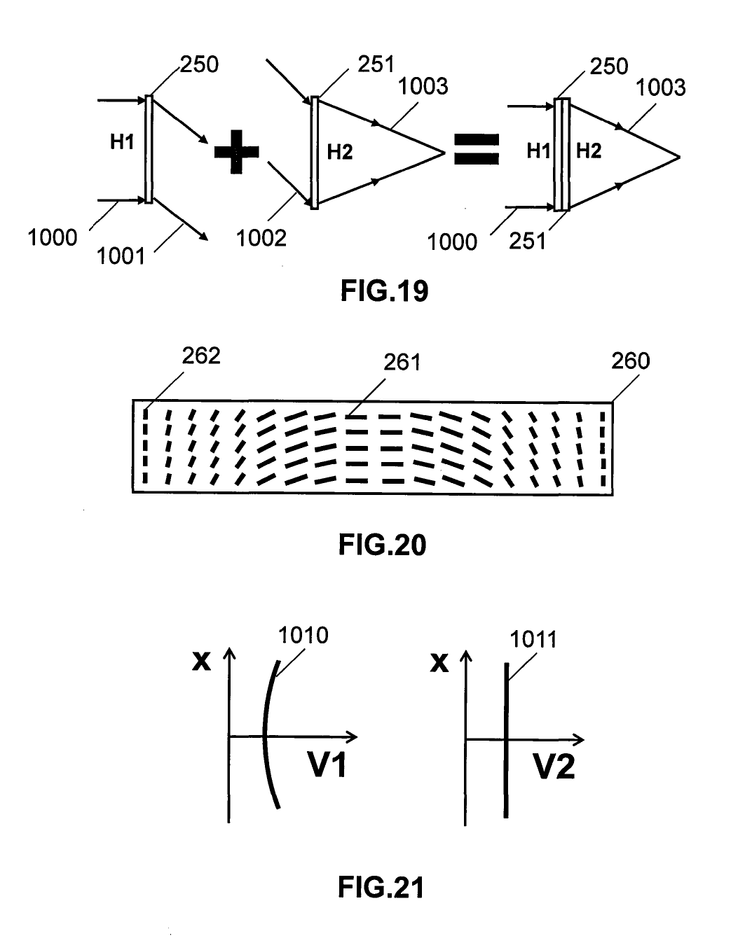

A passive holographic lens of the type used in the invention would be fabricated in two steps. In the first step a master is fabricated using one any the currently available processes for mastering diffractive optics. The master may be a surface relief grating of the type discussed above or may be a refractive lens. The master is copied into a holographic photopolymer using a standard holographic recording set-up. One approach is to record the properties directly into the hologram. While such single element in-line holographic lenses have been shown to have acceptable aberration and color correction at small fields it is generally preferable to use a two-layer solution in which the first hologram deflects input light a high angle diffracted beam which in turn provides the input beam for a second hologram which encodes the bulk of the optical power. When laminated together the two holograms provide the equivalent of an in-line hologram. This recording principle is illustrated in FIG. 19. The first hologram 250 (also labelled as H1) deflects the input beam 1000 into a deflected beam path 1001. The second hologram 251 (also labelled as H2) is focus the off axis input beam 1002 (corresponding to beam 1001) into the converging beam 1003. When the two holograms are laminated together the composite holograms focus the input barn 100 into the converging beam 1003 essentially providing an in-line holographic lens with a focal length defined by the distance from the hologram to the convergence point of the beam 1003. This is a more effective approach to recording the passive holographic lens. Holograms with larger bend angles tend to have higher efficiency. This type of solution is appropriate for the long focal lengths required in the contact lens application. High diffraction efficiencies and good correction of monochromatic aberrations and chromatic dispersion are feasible. Care must be taken to keep the hologram layer thicknesses as small as possible to minimize the total stack thickness sandwiched between the electrodes.

FIG. 20 is a simulation of an alignment layer for use in embodiments of the invention. The alignment layer 260 comprises a material containing at least one LC component. The LC molecules have directors with orientations varying from center to edge as illustrated by the director vectors 261,262.

In one embodiment illustrated in FIG. 21 the voltage applied by the electrodes has is controlled to provide a spatially varying voltage versus lateral coordinate. The voltage profile can be adjusted to provide curved profiles such as the one indicated by 1010 which can be used to control liquid crystal director alignment and hence the refractive index profile. A simple a planar voltage is indicated 1011. The spatially varying voltage may be used to fine tune the focal length or correct the aberrations of the focus-tunable lens.

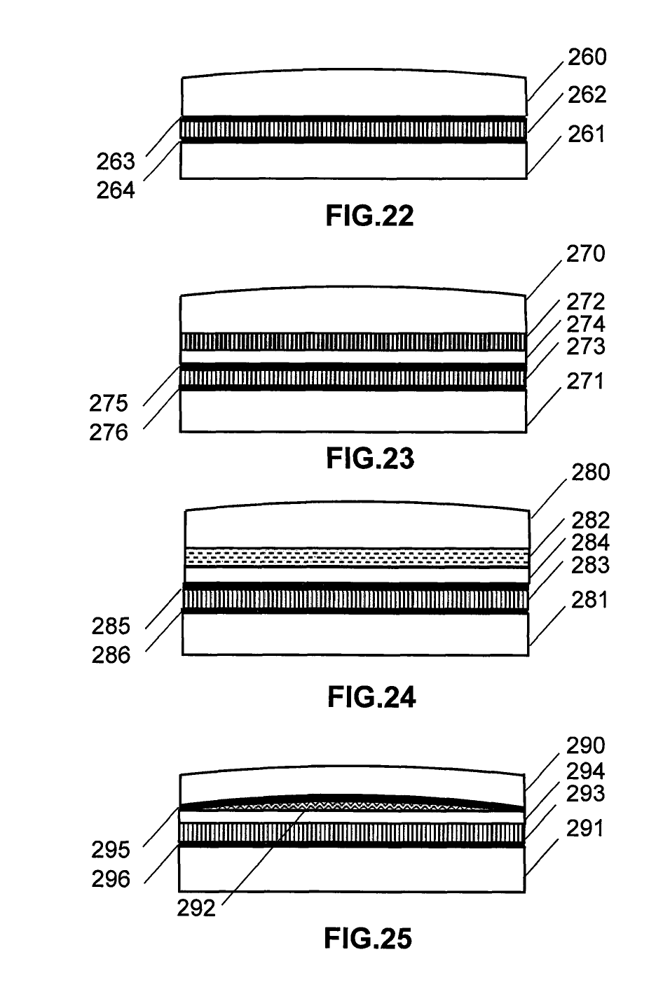

In one group of embodiments illustrated in FIGS. 22-25 the LC diffractive lens is provide by a SBG. Normally a SBG would provide two unique diffractive states which when combined with the power of the passive lens would provide two unique optical powers for use in an electrically switchable bifocal lens.

In one embodiment shown in FIG. 22 a focus-tunable lens comprises substrates 260,261 sandwiching the SBG 262. Non-patterned electrode 263,264 are applied to the opposing surfaces of the substrates. At least one of the substrates (260 in this case) has optical power provided by a curved surface or diffractive surface to provide the passive lens component.

In one embodiment shown in FIG. 23 a focus-tunable lens comprises substrates 270,271 sandwiching the passive holographic lens 272 and the SBG lens 273 and a third substrate 274. Non-patterned electrode 275,276 are applied to the opposing surfaces of the substrates 271,274 in order to switch the SBG. Advantageously, at least one of the substrates (270 in this case) may have optical power provided by a curved surface or a diffractive surface.

In one embodiment shown in FIG. 24 a focus-tunable lens comprises substrates 280,281 sandwiching the alignment layer 282 and the SBG lens 283 and a third substrate 284. Non-patterned electrode 285,286 are applied to the opposing surfaces of the substrates 281,284 in order to switch the SBG. Advantageously, at least one of the substrates (270 in this case) may have optical power provided by a curved surface or a diffractive surface.

In one embodiment shown in FIG. 25 a focus-tunable lens comprises substrates 290,291 sandwiching the liquid crystal layer 292, a SBG layer 293 and a third a transparent substrate 294. Non-patterned electrode 295,296 are applied to the opposing surfaces of the substrates 290,293 such that voltage is applied to the LC layer and SBG simultaneously. The LC layer is formed into a lens shaped by the inner curvature of substrate 290. The LC layer and SBG together provide a LC diffractive lens while the curved substrates provide a passive lens. Advantageously, at least one of the outer surfaces of substrates 290,291 (290 in this case) may have optical power provided by a curved surface or a diffractive surface.

In one embodiment the optical power of liquid crystal diffractive lens with no voltage applied and optical power of passive lens and substrates provides a minimum optical power. The optical power of the liquid crystal diffractive lens with voltage applied and optical power of passive lens and substrates provides a maximum optical power.

In one embodiment the invention provides a continuously tunable optic (providing optical power in the range: +0.00 and +3.00 diopters). In one embodiment the invention provides a three state device correcting for distant, intermediate, and near vision (for example: +0.00, +1.50, and +3.00 diopters). In one embodiment the invention provides a two state device correcting for distance and near vision. (for example: +0.00 and +3.00 diopters).

In one embodiment the invention provides a focus-tunable lens with a fail safe mode, that is, for the majority of the time it has zero optical power. The challenge is that since the passive hologram will always diffract (that is, it always has an optical power) it is necessary to provide an opposite optical power in the rest state of the contact lens. The solution proposed is to balance the power of the LC diffractive lens in its rest state against the powers of the passive lens and the substrates. It then remains for the LC diffractive lens in its active state to provide the dynamic focusing power.

In one embodiment the invention provides a color corrected focus-tunable lens. The passive hologram grating, LC layer index and substrate index and surface curvature provide an adequate design space for correcting color. The effectiveness of matched diffractive and curved surface in this regard is a well established optical design principle that is commonly used in achromatic singlets. The challenge is to establish a suitable correction point. Merely balancing the color in the rest state will not be satisfactory. A correction point will typically be located somewhere in the range from rest state (zero effective focal power) to maximum focal shift. In one embodiment the invention uses gratings design according to the principles of a Multi-Order Diffractive (MOD) lens. Conventional diffractive optics works best at a single wavelength; efficiency and contrast are reduced at other wavelengths. Correction (up to around 100% efficiency) at each of a set of discrete wavelengths is possible using a MOD lens with the number of wavelengths at which correction occurs depending on the number of lens digitization levels. MOD lenses tend to be a little deeper than conventional diffractive lenses.

The passive holographic lens used in the above described embodiments is desirably a Bragg grating (also referred to as a volume grating). Bragg gratings have high efficiency with little light being diffracted into higher orders. The relative amount of light in the diffracted and zero order can be varied by controlling the refractive index modulation of the grating, a property which is used to make lossy waveguide gratings for extracting light over a large pupil. One important class of Bragg gratings is known as Switchable Bragg Gratings (SBG). SBGs are fabricated by first placing a thin film of a mixture of photopolymerizable monomers and liquid crystal material between parallel glass plates. One or both glass plates support electrodes, typically transparent indium tin oxide films, for applying an electric field across the film. A volume phase grating is then recorded by illuminating the liquid material (often referred to as the syrup) with two mutually coherent laser beams, which interfere to form a slanted fringe grating structure. During the recording process, the monomers polymerize and the mixture undergoes a phase separation, creating regions densely populated by liquid crystal micro-droplets, interspersed with regions of clear polymer. The alternating liquid crystal-rich and liquid crystal-depleted regions form the fringe planes of the grating. The resulting volume phase grating can exhibit very high diffraction efficiency, which may be controlled by the magnitude of the electric field applied across the film. When an electric field is applied to the grating via transparent electrodes, the natural orientation of the LC droplets is changed causing the refractive index modulation of the fringes to reduce and the hologram diffraction efficiency to drop to very low levels. Typically, SBG Elements are switched clear in 30 μs. with a longer relaxation time to switch ON. Note that the diffraction efficiency of the device can be adjusted, by means of the applied voltage, over a continuous range. The device exhibits near 100% efficiency with no voltage applied and essentially zero efficiency with a sufficiently high voltage applied. In certain types of HPDLC devices magnetic fields may be used to control the LC orientation. In certain types of HPDLC phase separation of the LC material from the polymer may be accomplished to such a degree that no discernible droplet structure results. A SBG may also be used as a passive grating. In this mode its chief benefit is a uniquely high refractive index modulation. SBGs may be used to provide transmission or reflection gratings for free space applications. SBGs may be implemented as waveguide devices in which the HPDLC forms either the waveguide core or an evanescently coupled layer in proximity to the waveguide. The parallel glass plates used to form the HPDLC cell provide a total internal reflection (TIR) light guiding structure. Light is coupled out of the SBG when the switchable grating diffracts the light at an angle beyond the TIR condition. Waveguides are currently of interest in a range of display and sensor applications. Although much of the earlier work on HPDLC has been directed at reflection holograms transmission devices are proving to be much more versatile as optical system building blocks. Typically, the HPDLC used in SBGs comprise liquid crystal (LC), monomers, photoinitiator dyes, and coinitiators. The mixture frequently includes a surfactant. The patent and scientific literature contains many examples of material systems and processes that may be used to fabricate SBGs. Two fundamental patents are: U.S. Pat. No. 5,942,157 by Sutherland, and U.S. Pat. No. 5,751,452 by Tanaka et al. Both filings describe monomer and liquid crystal material combinations suitable for fabricating SBG devices. One of the known attributes of transmission SBGs is that the LC molecules tend to align normal to the grating fringe planes. The effect of the LC molecule alignment is that transmission SBGs efficiently diffract P polarized light (ie light with the polarization vector in the plane of incidence) but have nearly zero diffraction efficiency for S polarized light (ie light with the polarization vector normal to the plane of incidence. Transmission SBGs may not be used at near-grazing incidence as the diffraction efficiency of any grating for P polarization falls to zero when the included angle between the incident and reflected light is small.

In one embodiment the passive holographic lens is recorded in uniform modulation liquid crystal-polymer material system such as the ones disclosed in United State Patent Application Publication No.: US2007/0019152 by Caputo et al and PCT Application No.: PCT/EP2005/006950 by Stumpe et al. both of which are incorporated herein by reference in their entireties. Uniform modulation holographic gratings are characterized by high refractive index modulation (and hence high diffraction efficiency) and low scatter. In one embodiment the gratings are recorded in a reverse mode HPDLC material. Reverse mode HPDLC differs from conventional HPDLC in that the grating is passive when no electric field is applied and becomes diffractive in the presence of an electric field. The reverse mode HPDLC may be based on any of the recipes and processes disclosed in PCT Application No.: PCT/GB2012/000680, entitled IMPROVEMENTS TO HOLOGRAPHIC POLYMER DISPERSED LIQUID CRYSTAL MATERIALS AND DEVICES. The holographic grating may be recorded in any of the above material systems but used in a passive (non-switching) mode. The fabrication process is identical to that used for switched but with the electrode coating stage being omitted. LC polymer material systems are highly desirable in view of their high index modulation.

In a birefringent holographic grating the index has two components: extraordinary (nₑ) and ordinary (nₒ) indices. The extraordinary index is defined by the optic axis (ie axis of symmetry) of a uniaxial crystal as determined by the average LC director direction. The ordinary index corresponds to the other two orthogonal axes. More generally the index is characterised using a permittivity tensor. To the best of the inventors' knowledge the optic axis in LC-based gratings tends to align normal to the Bragg fringes ie along the K-vectors. For reasonably small grating slant angles applying an electric field across the cell re-orients the directors normal to the waveguide faces, effectively clearing the grating. An incident ray sees an effective index dependent on both the extraordinary and ordinary indices with the result that the Poynting vector and wave vector are separated by a small angle. This effect becomes more pronounced at higher angles. In one embodiment the polarization state of light diffracted by the passive holographic lens may be controlled by aligning the average relative permittivity tensor of the grating.

In one embodiment the passive holographic lens is one of a multiplexed set of holographic gratings. Each grating may operate over a defined angular or spectral range. Multiplexing allows the angular bandwidth and color space to be expanded without significantly increasing the number of waveguide layers. In one embodiment the grating has a spatially varying thickness. Since diffraction efficiency is proportional to the grating thickness while angular bandwidth is inversely propagation to grating thickness allowing the uniformity of the diffracted light to be controlled. In one embodiment the grating has spatially-varying k-vector directions for controlling the efficiency, uniformity and angular range of the grating. In one embodiment grating has spatially-varying diffraction efficiency. The application of multiplexing, and spatial varying thickness, k-vector directions and diffraction efficiency in the present invention is based on the embodiments, drawings and teachings provided in U.S. patent application Ser. No. 13/506,389 entitled COMPACT EDGE ILLUMINATED DIFFRACTIVE DISPLAY, U.S. Pat. No. 8,233,204 entitled OPTICAL DISPLAYS, PCT Application No.: US2006/043938, entitled METHOD AND APPARATUS FOR PROVIDING A TRANSPARENT DISPLAY, PCT Application No.: GB2012/000677 entitled WEARABLE DATA DISPLAY, U.S. patent application Ser. No. 13/317,468 entitled COMPACT EDGE ILLUMINATED EYEGLASS DISPLAY, U.S. patent application Ser. No. 13/869,866 entitled. HOLOGRAPHIC WIDE ANGLE DISPLAY, and U.S. patent application Ser. No. 13/844,456 entitled TRANSPARENT WAVEGUIDE DISPLAY.

In one embodiment the LC used in the LC diffractive lens is bistable. One of the key drawbacks of nematic-liquid-crystal technology is its monostability, which requires a continuous source of power to maintain a device state. For applications such as contact lenses it is desirable to reduce power consumption. LC displays rely on the ability of nematic LC to rotate the polarization plane of incident light. The degree to which this is possible depends on the orientation of the LC molecules. The main disadvantage of this approach is that an electric field must be applied constantly in order for the device to retain its LC alignment, the molecules relaxing into their rest states when the field is removed. This is expensive in terms of power consumption leading to shorter battery lifetimes. Bistable LC exploits the fact that the bound surfaces of a LC cell can be used to control the molecular alignment. Anchoring of the molecules at the surfaces can be controlled by mechanical or chemical treatments. This allows two stable LC states without requiring an electric field to sustain them. Power is required only to switch between the states. As the design of such electronics is a challenging problem the application of technology tends to be confined LC devices that change their only infrequently. This would be the case in a contact lens. Current bistable LC technology use the surface anchoring effect combined with novel bounding surface geometries.

In one embodiment a focus-tunable lens according to the principles of the invention provides a layer of a holographic waveguide display designed for near eye and head up display applications disclosed in the above references. In one embodiment focus-tunable lens according to the principles of the invention provides a provides a layer of a biometric sensor based on a holographic waveguide of the type disclosed PCT/GB2013/000005 entitled CONTACT IMAGE SENSOR USING SWITCHABLE BRAGG GRATINGS. In one embodiment a focus-tunable lens according to the principles of the invention provides a layer of a light field display.

It should be emphasized that the drawings are exemplary and that the dimensions have been exaggerated. For example, thicknesses of the SBG layers have been greatly exaggerated.

In any of the above embodiments the waveguides may be curved or formed from a mosaic of planar or curved facets.

A waveguide device based on any of the above-described embodiments may be implemented using plastic substrates using the materials and processes disclosed in PCT Application No.: PCT/GB2012/000680, entitled IMPROVEMENTS TO HOLOGRAPHIC POLYMER DISPERSED LIQUID CRYSTAL MATERIALS AND DEVICES.

It should be understood by those skilled in the art that while the present invention has been described with reference to exemplary embodiments, it is to be understood that the invention is not limited to the disclosed exemplary embodiments. Various modifications, combinations, sub-combinations and alterations may occur depending on design requirements and other factors insofar as they are within the scope of the appended claims or the equivalents thereof.

What is claimed is:

1. An electrically focus-tunable lens comprising:
a passive lens;
a liquid crystal diffractive lens;
a first transparent substrate with a first electrode is applied to one surface; and
a second transparent substrate with a second electrode applied to one surface.
said electrodes operative to apply at least one voltage across said LC diffractive lens layer.

2. The apparatus of claim 1 wherein said passive lens is a hologram of one of a multilevel diffractive structure or a refractive lens.

3. The apparatus of claim 1 wherein said liquid crystal diffractive lens is a switchable hologram of one of a multilevel diffractive structure or a refractive lens, said switchable hologram providing at least two unique optical powers.

4. The apparatus of claim 1 wherein said passive lens is a substrate having a surface relief grating formed in one surface.

5. The apparatus of claim 1 wherein said passive lens is a refractive medium having at least one curved surface.

6. The apparatus of claim 1 wherein said liquid crystal diffractive lens is a liquid crystal layer.

7. The apparatus of claim 1 wherein said liquid crystal diffractive lens comprises a substrate having a surface relief grating formed in one surface and a liquid crystal layer in contact with said surface relief grating.

8. The apparatus of claim 1 wherein said passive lens is a surface relief grating said liquid crystal diffractive lens is a liquid crystal layer, where said liquid crystal layer is in contact with said surface relief grating.

9. The apparatus of claim 1 further comprising an alignment layer.

10. The apparatus of claim 1 further comprising a layer containing liquid crystal or a reactive mesogen having a spatially-varying distribution of director orientations.

11. The apparatus of claim 1 further comprising at least one barrier layer.

12. The apparatus of claim 1 wherein at least one surface of at least one of said substrates has refractive or diffractive optical power.

13. The apparatus of claim 1 wherein said first electrode is patterned with a multiplicity of selectively addressable concentric rings, each ring and said second electrode operative to apply at least one voltage across a region of said liquid crystal diffractive lens overlaid by said ring.

14. The apparatus of claim 1 wherein said first electrode is patterned with a multiplicity of selectively addressable concentric rings each said ring containing two or more selectively addressable concentric rings, each ring and said second electrode operative to apply at least one voltage across a region of said liquid crystal diffractive lens overlaid by said ring.

15. The apparatus of claim 1 wherein said first electrode is patterned with an array of selectively addressable pixels, each pixel and said second electrode operative to apply at least one voltage across a region of said liquid crystal diffractive lens overlaid by said pixel.

16. The apparatus of claim 1 configured as a curved stack.

17. The apparatus of claim 1 wherein said passive lens contains a conductive additive.

18. The apparatus of claim 1 wherein the optical power of said liquid crystal diffractive lens with no voltage applied and the optical power of said passive lens and said substrates together provides a minimum predefined optical power, wherein the optical power of said liquid crystal diffractive lens with voltage applied and the optical power of said passive lens and said substrates together provide a maximum predefined optical power.

19. The apparatus of claim 1 wherein said liquid crystal diffractive lens is a Bragg grating or a Switchable Bragg Grating and is recorded in one of a HPDLC grating, uniform modulation grating or reverse mode HPDLC grating.

20. The apparatus of claim 1 wherein said liquid crystal diffractive lens is fabricated in a material containing at least one bistable liquid crystal.
